(19) United States
(12) Patent Application Publication
(10) Pub. No.: US 2003/0202116 A1
(43) Pub. Date: Oct. 30, 2003

(54) Camera able to freely rotate with 306o

(76) Inventors: Kuo-Liang Lin, Taipei Hsien (TW); Chiew-Hsin Chian, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/063,438

(22) Filed: Apr. 24, 2002

(51) Int. Cl. H04N 5/225

(52) U.S. Cl. 348/373

(57) ABSTRACT

A camera that can freely rotate with an angle of 360° , having a seat unit, a camera unit, and a connecting-fitting unit. One side of the camera unit has a plurality of concentric transmission circular traces, while the other side of the camera unit has a plurality of conductive rolling units corresponding to the transmission circular traces. The connecting-fitting unit is used to mount the camera unit on the seat unit, and to put the conductive rolling units and the transmission circular traces in electric contact. The camera can freely rotate while the electric contact is maintained at the same time. The power source of the camera unit and the signal input/output can be transmitted outwardly through the conductive rolling unit by the conductive circular traces.

### BACKGROUND OF INVENTION

1. Field of the Invention

The present invention relates in general to a camera technique, and more particularly, to a camera able to freely rotate with an angle of 360°.

2. Description of the Related Art

The camera is a commonly seen electronic device that can record an audio-video signal of our daily lives. In addition to recording daily life for entertainment purposes, the camera can also be applied as a surveillance monitor for a security system. The surveillance camera is normally mounted on a seat. The power source of the surveillance camera is normally the signal output line, and these conductive lines have to be connected to the surveillance camera.

Being restricted by the transmission line and the power line, the current surveillance camera cannot freely rotate with a full angle of 360°. When the operator finds something suspicious, the surveillance camera cannot be controlled to rotate to a dead angle.

Referring to FIG. 1, the structure of a suspension type surveillance camera is shown. A camera 102 is mounted on a seat 100 or a wall via a bearing 104. The required power of the camera 102 is provided by a power line in a conductive line set 106. The signal taken by the camera 102 is output through a signal line of the conductive line set 106. In such structure, when the camera 102 is rotated to align with something suspicious, the conductive line set 106 has to be rotated consequently causing obstruction of rotation. Therefore, the conventional camera 102 cannot freely rotate with a full angle of 360°. As a result, a dead angle at which something suspicious may be located cannot be monitored.

The problems occurring to the above camera 102 also occur to other similar applications. When the camera or any electronic equipment is mounted on a seat, the free rotation thereof is always obstructed by the conductive lines thereof or connected thereto.

### SUMMARY OF INVENTION

The present invention provides a camera that freely can rotate with an angle of 360°, so that a full-angle view can be obtained without being restricted by the conductive line.

The present invention provides a camera that can freely rotate with an angle of 360°. The required power and signal input/output is not provided by a conductive line; therefore, the camera can freely rotate with an angle of 360° without being restricted.

In the camera that can freely rotate with an angle of 360°, the power and signal input/output is obtained by electrical contact between a conductive rolling wheel and a transmission circular trace, where the conductive rolling wheel can freely rotate on the corresponding transmission circular trace. Therefore, the rotation obstacle of the conductive line is removed.

The camera that can freely rotate with an angle of 360° comprises a seat, a camera unit and a connecting-fitting unit. One side of the camera unit comprises a plurality of concentric circular traces, while one side of the seat comprises a plurality of conductive rolling units corresponding to the transmission circular traces. The connecting-fitting unit is used to mount the camera unit on the seat and to put the conductive rolling wheels in electric contact with the transmission circular traces. The camera can freely rotate while the electric contact is maintained at the same time. The required power and signal input/output of the camera is transmitted outwardly by the transmission circular traces via the conductive rolling units.

The above camera that can freely rotate with an angle of 360° is applicable to a video surveillance system to eliminate the monitor dead angle.

The present invention further comprises a signal input/output method for a camera. A plurality of transmission circular traces is formed on one side of a camera unit. The transmission circular traces have a concentric circular structure. Each of a plurality of terminals of the camera unit is connected to the corresponding transmission circular traces, where the terminals include a power terminal and an optional signal input/output terminal. A seat is further provided to allocate a plurality of conductive rolling units on one side thereof. Each of the conductive rolling units is located corresponding to one of the transmission circular traces. The camera unit is mounted on the seat, and the conductive rolling units are brought in electric contact with the transmission circular traces, so that the camera unit can freely rotate over the side of the seat.

The above signal input/output method for a camera further comprises connecting the conductive rolling units to a plurality of corresponding conductive lines.

The above signal input/output method for a camera further comprises allocating a motor on the camera unit to rotate the camera unit.

Both the foregoing general description and the following detailed description are exemplary and explanatory only and are not restrictive of the invention, as claimed.

### BRIEF DESCRIPTION OF DRAWINGS

FIG. 1 shows the structure of a conventional suspension type surveillance camera;

FIGS. 2A to 2B show the structures of suspension type and the desktop surveillance camera according to the present invention;

FIG. 3 shows the signal transmission structure of the camera according to the present invention;

FIG. 4A shows a top view of a seat corresponding to a transmission circular trace of the camera according to the present invention; and

FIG. 4B shows a cross sectional view along the cutting line 1-1 in FIG. 4A.

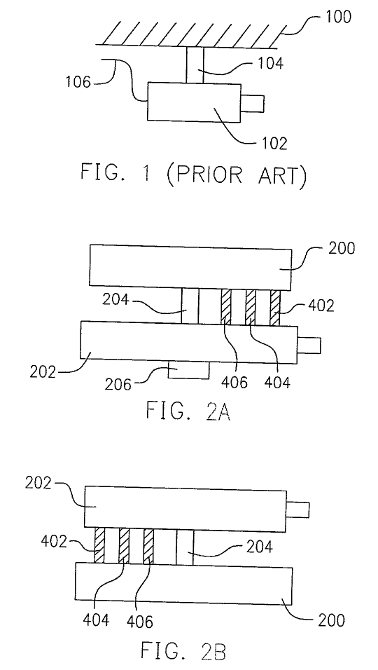

### DETAILED DESCRIPTION

The present invention designs a transmission circular trace located on the enclosure of electronic equipment to replace the conventional conductive line. The electronic equipment includes a camera. A seat that comprises conductive rolling wheels corresponding to transmission circular traces of the camera is provided and is used to accommodate the camera.

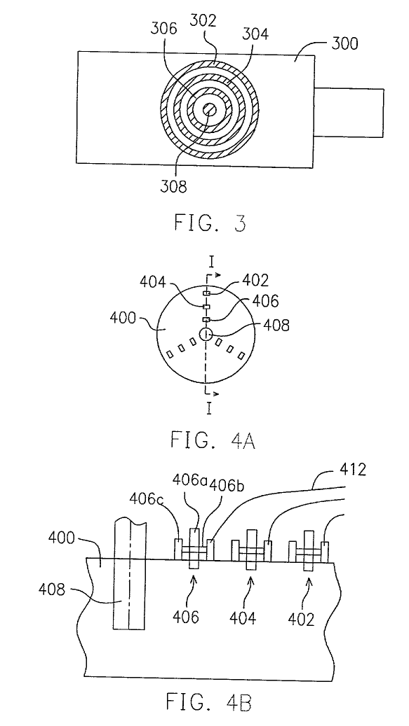

Hereinafter, an embodiment of the present invention is described. FIGS. 2A to 2B illustrate the structures of a suspension type surveillance camera and a desktop surveillance camera, respectively. In FIG. 2A, the suspension type structure is shown. A camera unit 202 is mounted on a seat 200 via a connecting unit 204, for example, a bearing 204. Conductive rolling wheels 402, 404 and 406 are allocated on one side of the seat 200 to be in contact with the camera unit 202. Transmission circular traces 302-306 are formed on the camera unit 202 (referring to FIG. 3) and are electrically connected to the conductive rolling wheels 402-406. The terminals required by the camera 202, for example, the power terminal, ground terminal, or signal input/output terminal, belong to part of the transmission circular traces 302-306. The input/output of the camera 202 is achieved by the transmission rolling wheels 402, 404 and 406 via the seat 200. In FIG. 3 and FIGS. 4A-4B, the terminal connection mechanism is further illustrated.

The camera 202 can rotate over the seat 202 after being mounted thereon via the bearing 204. Since the conventional conductive line set 106 does not exist, a full-angle orientation can be achieved. In addition, if the surveillance system cannot be manually rotated, a motor 206 can be optionally installed to control the camera 202. The circuit of the control motor 206 includes inputting power and control signal via the transmission circular traces. The circuit board (not shown) of the control motor can be allocated on the other side of the camera 202. The principle of allocation is to avoid obstruction of rotation of the camera. The seat 200 can be disposed on a ceiling of a room.

FIG. 4B shows the arrangement of desktop camera 202. The connection mechanism between the camera 202 and the seat 200 is similar to that shown in FIG. 4A.

Referring to FIG. 3, the signal transmission structure of a camera is shown. Transmission circular traces 302 to 306 with a concentric structure are formed on the side of the camera 300 to be in contact with the seat. The connecting unit between the camera 300 and the seat includes a bearing. The terminal of the camera 300 is connected to an external device via the transmission circular traces 302 to 306. The transmission circular traces 302 to 306 include the power source terminal, the ground terminal or the signal input/output (I/O) terminal. The number and type of the terminals is determined according to specific requirements. According to the design of the present invention, the camera does not have to connect with a traditional conductive line.

The structure of the seat 400 is shown as FIG. 4A to 4B. FIG. 4A is a top view showing the seat structure of the transmission circular traces of the camera, while FIG. 4B shows a cross sectional view along a cutting line 1-1 of FIG. 4B.

In FIG. 4A, conductive rolling (wheels) units 402 to 406 are allocated on the seat 400. The material of the conductive rolling units 402 includes copper or other conductive materials. The positions of the conductive rolling units 402 to 406 are determined according to the positions of the transmission circular traces 302 to 306 of the camera 300. Therefore, when the camera 300 is rotating over the seat 400, electrical contact between the conductive rolling units 402 to 406 and the transmission circular traces 302 to 306 is maintained to supply power to the camera 300 and to output the signal taken by the camera 300.

To obtain a good electric contact between the transmission circular traces 302 to 306 and the rolling wheels on the seat 400, three rolling units are designed for each transmission circular trace. These three rolling units are positioned with an angle of 120° between each other. Thereby, the camera 300 can be stably mounted on the seat 400 with a good electrical contact. With the bearing 408 as the center, the rolling units 402 to 406 are distributed outwardly in the radial direction corresponding to the transmission circular traces 302 to 306.

In FIG. 4B, the structure of the rolling units 402-406 includes a conductive rolling wheel 406a, a conductive rolling bearing 406b and a supporting frame 406c to fix the conductive rolling bearing 406b. The conductive rolling wheel 406a is rolling about the center axle, that is, the rolling bearing 406b. The material of the rolling wheel 406a and the conductive rolling bearing 406b includes conductive material, while the supporting frame 406 can be made of either conductive or non-conductive material. In addition, the rolling units 402-406 can be electrically connected to corresponding conductive lines 412. When the rolling units 402 to 406 and the transmission circular traces 302 to 306 are in electrical contact, the conductive lines 412 such as power source line, the ground line and the signal output line are consequently connected.

On the other hand, a connecting unit 408 is used to mechanically mount the camera 300 on the seat 400. The connecting unit 408 includes a bearing allowing the camera 300 to rotate over the seat 400. The connecting unit 408 includes typical connecting devices, and therefore a detailed description is not further given here. The present invention can thus be characterized by replacing the conventional transmission cable with the non-conductive line type transmission circular traces 302 to 306 to electrically contact with the conductive rolling units, so that the rotation obstacle is removed.

Therefore, the camera 300 is connected to a power source and able to output signal without connecting with a cable. The conductive line or wire 412 can be fixed on the seat 400 without restriction the motion of the camera 300.

Other embodiments of the invention will appear to those skilled in the art from consideration of the specification and practice of the invention disclosed herein. It is intended that the specification and examples be considered as exemplary only, with a true scope and spirit of the invention being indicated by the following claims.

1. A camera that can freely rotate with an angle of 360°, comprising:
a seat unit;
a plurality of conductive rolling units, allocated on one side of the seat;
a plurality of conductive lines, connected to the conductive rolling units corresponding thereto;
a camera unit, comprising a plurality of transmission traces in a form of a concentric circular structure on one surface thereof, the camera unit functioning as a plurality of terminals of the camera unit, wherein the terminals include a power source terminal and an optional signal input/output terminal; and
a connecting-fitting unit, mounting the camera unit on the seat unit, allowing the conductive rolling units to be in electrical contact with the corresponding transmission traces, and allowing the camera to freely rotate over the side of the seat that has the conductive rolling units.

2. The camera according to claim 1, further comprising a power source line and a signal line connected to the corresponding conductive rolling units of the seat to output signal and provide power required by the camera.

3. The camera according to claim 1, wherein each conductive rolling unit is corresponding to three of the conductive rolling units positioned with a 120° between each other.

4. The camera according to claim 1, wherein each conductive rolling unit comprises a conductive rolling wheel, a conductive rolling bearing of the conductive rolling wheel, and a supporting frame to support the conductive rolling bearing.

5. The camera according to claim 1, further comprising a motor to rotate the camera unit.

6. The camera according to claim 5, wherein the motor comprises a circuit board located on the other side of the camera.

7. The camera according to claim 1, wherein the connecting-fitting unit further comprises a bearing to allow the camera unit to freely rotate thereon.

8. The camera according to claim 1, wherein the camera comprises either a suspension type or a desktop.

9. A rotatable input/output terminal structure, applicable for power supply and signal input/output of an electronic apparatus, wherein the electronic apparatus is installed on a seat and has the function of freely rotating with an angle of 360°, the input/output terminal structure comprising:
a plurality of transmission traces formed on one side of the electronic apparatus, wherein the transmission traces have a concentric circular structure and are electrically connected to a plurality of terminals of the electronic apparatus, including a power source terminal and a optional signal input/output terminal;
a plurality of conductive rolling units, allocated on one side of the seat, wherein a position of each of the conductive rolling units is corresponding to one of the transmission traces, and when the electronic apparatus is installed on the seat, the conductive rolling units are in electric contact with the transmission traces to allow the electronic apparatus to rotate over the seat; and
a plurality of conductive lines, electrically connected to the conductive rolling units to provide a power source and a signal input/output to the electronic apparatus.

10. A signal input/output method of a camera, comprising:
forming a plurality of transmission traces on one side of a camera unit, wherein the transmission traces have a concentric circular structure;
connecting the transmission traces to a plurality of corresponding terminals, wherein the terminals include a power source terminal and an optional signal input/output terminal;
providing a seat unit;
allocating a plurality of conductive rolling units on one side of the seat unit, wherein a position of each conductive rolling unit corresponds to a position of the corresponding transmission trace;
providing a plurality of conductive lines to connected to the conductive rolling units; and
mounting the camera unit on the seat to bring the conductive rolling units in electrical contact with the transmission traces, wherein the camera unit can freely rotate over the seat.

11. The method according to claim 10, further comprising connecting the conductive rolling units to the corresponding conductive lines.

12. The method according to claim 10, further comprising a step of allocating a motor to the camera unit for rotating the camera.
